(19) United States
(12) Patent Application Publication
(10) Pub. No.: US 2007/0233360 A1
(43) Pub. Date: Oct. 4, 2007

(54) Fuel System

(75) Inventors: David Hill, Commerce Township, MI (US); Ryan McCleary, White Lake, MI (US)

Correspondence Address: OBLON, SPIVAK, MCCLELLAND, MAIER & NEUSTADT, P.C., 1940 DUKE STREET, ALEXANDRIA, VA, 22314, US

(73) Assignee: INERGY AUTOMOTIVE SYSTEMS RESEARCH (SA), Brussels (BE)

(21) Appl. No.: 11/587,529

(22) PCT Filed: Apr. 21, 2005
(86) PCT No.: PCT/EP05/51788

§ 371 Date: Oct. 25, 2006

Related U.S. Application Data
(60) Provisional application No. 60/564,961, filed on Apr. 26, 2004.

(51) Int. Cl. G06F 19/00

(52) U.S. Cl. 701/123

(57) ABSTRACT

A vehicle fuel system for an internal combustion engine comprises a fuel tank, at least one fuel system component, at least one sensor (4, 5, 6) and a fuel system control unit (FSCU). The FSCU (2) is different from an engine control system (1) and has means for controlling functions of the fuel system. It is connected with at least one fuel system component to send signals or receive signals from it. It is also connected to at least one sensor (4, 5, 6) that sends signals to the FSCU (2) and/or the engine control system. It is adapted to electronically communicate with the engine control system. This FSCU (2) is external to the fuel tank.

A vehicle fuel system for an internal combustion engine comprises a fuel tank, at least one fuel system component, at least one sensor and an electronic control module (ECM). The ECM is different from an engine control system and has means for controlling functions of the fuel system. It is connected with at least one fuel system component to send signals or receive signals from it. It is also connected to at least one sensor that sends signals to the ECM and/or the engine control system. It is adapted to electronically and bi-directionally communicate with the engine control system. This ECM is external to the fuel tank.

The invention relates to a fuel system.

Traditionally, automotive fuel systems have used a variety of mechanical and electronic components to perform the various functions required to store and deliver fuel in compliance with the various safety standards imposed on it. While the mechanical components on the tank are self sufficient, the electronic components rely on the vehicle's engine control system (generally the engine control system or ECS), to receive and interpret data from and send signals to fuel system components and/or sensors. As technology moves forward, it becomes possible to replace mechanical systems with more responsive electronic components.

Therefore electronically controlled solutions for specific components have been developed by fuel system component suppliers who embodied their expertise on a given component. In doing so, the most cost-effective way to control one component is through the engine control system. While this is logical for one component, as more components become electronically controlled, the ECS becomes overloaded, requiring expansion. In other words, additional electronic components create an additional burden on the engine control system.

By creating an integrated controller that independently controls all functions of the fuel system, commonization between different Overall Equipment Manufacturers (OEM) becomes more feasible. The obvious results of this are the decrease in cost, and the decrease in warranty concerns, from the ability to devote a larger engineering staff to the design of the product. The past solutions do not achieve this goal, making them infeasible for the replacement of current passive systems.

U.S. Pat. No. 6,302,144 discloses an electronic control module received within a fuel tank: it controls all functions of the fuel system and communicates with the ECS. But there is a drawback in attaching the control module within the fuel tank since permeation problems can become a major issue during the tank lifetime. A particular attention has to be focused on fluid-tight solutions to embody the electronic control module.

To avoid this problem, the invention relates to a fuel system for an internal combustion engine operating with the aid of an engine control system, the fuel system comprising a fuel tank, at least one fuel system component exercising at least one function, at least one sensor and a fuel system control module (FSCU) controlling at least said function, the FSCU
a) being different from an engine control system,
b) being external to the fuel tank.

A “tank” is to be understood as meaning a closed chamber, of varying shapes, generally sealed against the outside, which may be equipped with various internal accessories or accessories passing through the wall of the chamber.

The tank according to the invention may be made of any composition or material compatible with the fuels and the habitual conditions of use. It may, for example, be made of a material the composition of which contains at least one metal or one plastic. Tanks made up of at least one plastic are preferred.

“Plastic” is intended to denote any material containing at least one polymer. Thermoplastic polymers are preferred. The term “polymer” is intended to denote both homopolymers and copolymers (particularly binary or ternary ones). Examples of such copolymers are, without implying any limitations: random copolymers, copolymers from sequenced polymerization, block copolymers and graft copolymers.

The thermoplastic polymers also comprise thermoplastic elastomers and blends thereof.

Any type of thermoplastic polymer or copolymer whose melting point is below the breakdown temperature is suitable. Synthetic thermoplastics which have a melting range spread over at least 10° C. are particularly well-suited. Examples of such substances are those which have a polydispersion of their molecular mass.

In particular, the hollow body may contain polyolefins, graft polyolefins, thermoplastic polyesters, polyketones, polyamides and copolymers thereof.

A polymer often present in the hollow body is polyethylene. Excellent results have been obtained with high-density polyethylene (HDPE).

A copolymer often used is the ethylene-vinyl alcohol (EVOH) copolymer. A blend of polymers or copolymers may also be used, as may a blend of polymeric substances with inorganic, organic and/or natural fillers such as, for example, but without implying any limitation: carbon, inorganic salts and other inorganic derivatives, natural or polymeric fibers.

Tanks made of plastic may be in the form of single-layer or multilayer tanks. Tanks comprising one or more layers of high-density polyethylene (HDPE) are particularly preferred.

Such multi-layer structures consist of polymeric layers stacked and secured together containing at least one of the polymers or copolymers described above. These multi-layer structures may contain at least one barrier layer. This layer is on the inside of the multi-layer polymeric structure and therefore surrounded on both sides by at least one layer of plastic, the barrier properties of which are weaker. Usually, the layers situated on either side near a barrier layer have somewhat insignificant barrier properties.

“Barrier layer” means a layer which is impermeable to gases and to liquids. It generally contains a barrier resin. Any known barrier resin may be present in the hollow body, provided that it is effective with respect to the fluids likely to be in contact with this hollow body, particularly hydrocarbons, and provided that it is compatible with the technique used to manufacture the multi-layer structure.

Non-limiting examples of possible resins that may be mentioned are polyamides or copolyamides and random copolymers of ethylene and of vinyl alcohol. A blend of different barrier resins is also possible. Very good results have been obtained with a hollow body containing a barrier resin made of a random copolymer of ethylene and of vinyl alcohol.

A “fuel” is to be understood as meaning any chemical composition capable of being burnt in the presence of an oxidizing agent, generally the oxygen in the air, which can be used in a combustion engine. Fuels may at ambient temperature be in any one of three states—solid, liquid or gaseous. In vehicles, preference is generally given to fuels which are liquid or gaseous at ordinary temperature and at atmospheric pressure or higher. Liquid fuel such as petrol and diesel are particularly preferred.

The fuel contained in the tank according to the invention is intended to be burnt in any combustion device employing an oxidizing agent such as air or oxygen, for example central heating boilers or combustion engines. Usually, it supplies a combustion engine of a vehicle.

A “combustion engine” is to be understood as meaning any engine that converts the chemical energy contained in a fuel into mechanical energy. This may be any type of internal combustion engine, of the piston or rotary type, using liquid fuel (such as petrol, heavy oil, alcohol, etc.) or gaseous fuel (such as petroleum gas, natural gas, lean gas, hydrogen, methane, etc.). By extension, a “combustion engine” is also intended to cover one or more electric motors powered by at least one fuel cell when this fuel contains at least one hydrocarbon and/or an alcohol.

According to the invention the fuel system comprises a fuel tank, at least one fuel system component and an electronic fuel system control unit or FSCU. With this minimum configuration, the FSCU can manage the fuel system operating conditions and functioning parameters.

In a particular embodiment of the fuel system, the FSCU
a) has means for controlling functions of the fuel system,
b) is connected with the at least one fuel system component to send signals or receive signals from said at least one fuel system component,
c) is connected with at least one sensor that sends signals to the FSCU and/or the engine control system, either directly or on a network system contained within the vehicle.
d) is adapted to electronically communicate with the engine control system.

The FSCU receives and/or sends signals and/or data from/to at least one sensor and at least one fuel component. The FSCU is a standalone controller, different from the engine control system (ECS) and which has taken over the control of the fuel system from the ECS, i.e. the ECS doesn't directly control the fuel system any longer. Nonetheless the FSCU communicates with the ECS at least for indication of any fuel system failure to the ECS.

One of the essential characteristics of the invention is the fact that the FSCU is external to the fuel tank. This location of the FSCU has advantages: no volume inside the fuel tank is taken up by the FSCU, particularly if the FSCU is boxed in a casing; there is no risk of damage to the controller due to a permanent contact with fuel: even with a dedicated casing it is difficult to keep a completely tight environment around the FSCU. There is also more freedom to locate the FSCU at the best position in the neighbourhood of the fuel tank. Additionally the external location of the FSCU helps replacing it more easily.

It is preferred to mount the FSCU to the fuel tank since this is an opportunity to reduce the connection lengths to the sensors and fuel system components. It also significantly reduces the number of wires that would be required if all the functions of the fuel system were to be controlled by the ECS.

By “mounting” the FSCU to the fuel tank it is meant that the FSCU is attached to the wall of the tank or to any component attached directly to the tank.

A particular embodiment of the invention consists of a flange-mounted FSCU. In that embodiment, a communization of the controller setup is possible: the FSCU is totally independent of the fuel tank shape or architecture since it is attached to the flange and not to the fuel tank. Accordingly the tank flange includes all requested connection plugs for the controller to be connected to all components and sensors of the fuel system: the flange acts as an interface between components and sensors on the one side and the controller on the other side.

More particularly the flange can be the fuel delivery module flange.

In a preferred embodiment, the FSCU is mounted in a recess present either in the tank wall, or in the above mentioned flange. Said recess is then preferably sized and shaped in order to receive not only the FSCU itself, but also all associated parts like heat sink, assembly brackets . . . . Recesses integrating a heat sink as (part of) a cover are preferred. There are two possible configuration types for the assembly in that case:
1. Cover or heat sink perpendicular to circuit board of control unit. In this situation, the bottom edge of the circuit board would function similar to a card edge connector found on computers (ISA/PCI/etcetera) or would serve as a location to mount spade (or similar) terminals if the card edge connection method can not be made suitable for the automotive environment.
2. Cover or heat sink parallel to the circuit board of the control unit. In this situation, electrical connection would be facilitated with a pin/socket (or similar) combination perpendicular to the circuit board surface or of the card edge type into a horizontal socket.

A silicone or other type of pliable material may be used to encase the circuit board in a shape similar to the mounting location to increase resistance to moisture and other leakage (fuel, oil, etc.).

The mounting location (recess) will be on the fuel tank (plastic or steel) or fuel tank flange (covering an opening of the fuel tank). The mounting location will be a cavity or similar molded or stamped enclosure on the surface of the tank or flange. This cavity or enclosure would be created with the necessary dimensions to accommodate the control unit. A wiring harness can be integrated into the cavity to facilitate the electrical connection requirements of the control unit. A gasket of a material to be determined can be used between the cover/heat sink of the control unit and the edge around the cavity or enclosure to seal out moisture, fuel, oil, etc. Ribs in the side of the cavity or mold may be utilized to provide extra seal points between the cover/heat sink of the control unit and the location of the wiring harness. In the flange version, the wiring harness could be molded into the flange when it is molded. In the tank surface version, the wiring harness could be integrated when the tank is blow molded.

The following are methods which can be used to securely fasten the control unit into the mounting location (recess):
1. Snap-in posts or clips molded into the mounting location that would clip around the edge of the heat sink/cover or into holes in the heat sink/cover. The posts/clips would provide the necessary pressure to hold the control unit assembly in the mounting location.
2. Extruded clips in the bottom of the heat sink, allowing it to clip onto a pair of recessed features on the mounting location.
3. Binding posts at the mounting location with integrated hole or ridge, used with matching e-clip, pin, or similar to hold the control unit into place.
4. A curved stamped piece of steel attached to nubs on either side of the mounting cavity or enclosure and routed through a channel between the fins of the heat sink on the control unit or across the surface of a cover. This piece of steel would exert pressure on the control unit and would provide the necessary pressure to hold the control unit assembly in the mounting location.
5. Matching grooves (or other suitable surface) made horizontally in the mounting location and the heat sink.

This mounting method (in a recess of the tank wall or flange) results in lower material and assembly cost as compared to enclosing the electronic control unit in a completely separate package from the fuel tank especially if using an integrating a heat sink. In addition, the integrated wiring harness (to connect the control unit) reduces cost and increases ease of assembly. If the external wiring harness (to connect the tank to the vehicle) is integrated into the tank, the modularity of the system will increase, and further cost reduction may be achieved. The methods of securing the control unit into the recess of the tank or flange which are described above, do not require any tools and will reduce assembly and replacement labor cost. Finally, when the recess used is in the tank wall itself, it can be molded by using a stamped steel form (like a ring for instance) during molding of the tank itself, which is cost effective.

Alternatively or additionally, the FSCU can be mounted to a moulded-in element on the tank wall that can securely hold the FSCU for the whole life of the vehicle. The moulded-in element can be a mounting member moulded in the tank wall previously to the mounting of the FSCU. This mounting can be a snap fit.

The FSCU may also be mounted to an overmoulded fixation element, i.e. a fixation element that has been overmoulded on the tank's wall.

The FSCU may also be located in a casing. In that situation, another alternative embodiment consists in welding the casing of the FSCU to the tank wall.

“Welding” means that the elements are fixed by contact and partial interpenetration of the molecules of a portion of the surface of the first element with the molecules of a similar surface of the second element. This can be advantageously obtained by increase of the temperature of the surfaces of welding, for instance by heating the surfaces.

According to the invention, the FSCU is in contact with a least one fuel system component. In general an equipped fuel system integrates among other components, a fuel pump (which draws fuel from the fuel tank and discharges fuel from the fuel tank through an opening in the fuel tank wall), a fuel vapour canister (that is disposed within the fuel tank and through which any air received into or discharged out of the fuel tank travels), one or several vapour or roll-over-valves (communicating with the fuel vapour canister) or any other fuel system component. The FSCU controls the operation of all these components during normal and transient operating conditions of the engine, receives data on the operating parameters and sends information to make the component function In general this control was previously made by the ECS or by component-dedicated electronic controllers (for instance, specific controllers exist for fuel pump management). The burden of controlling the fuel system is switched to the FSCU.

Preferably the FSCU is electronically connected to sensors integrated in the fuel system. Among fuel system sensors there are an electronic fuel level sensor, a temperature sensor, an analog pressure sensor, a hydrocarbon vapour sensor, and one or several On-Board-Diagnostic (OBD) sensors. Other types of sensors can be part of this list. They are connected to the FSCU by appropriate electric wires through which sensors transmit data to the FSCU.

The FSCU may receive information from and send information to a plurality of vehicle control systems including the ECS through a limited number of wires. The information exchanged between the FSCU and the ECS includes for instance the quantity of fuel in the fuel tank (returned from the fuel level sensor), the required fuel line pressure, a signal indicating if purge conditions for the canister are met, etc. . . .

The FSCU may also receive signals from OBD sensors used to determine if there are any fuel system component failures or failures in the evaporative emission control system which may be indicated, for example, by liquid fuel leakage or pressure losses in the system. These failure conditions may result in the discharge of liquid fuel or hydrocarbon vapours from the fuel system. OBD sensors may also indicate vacuum conditions in the fuel tank.

In another embodiment of the present invention the FSCU controls the application of electrical power to the fuel pump. The fuel pump speed may be controlled by a pulse-width-modulated current that is generated by the FSCU according to any request from the ECS for fuel delivery to the fuel injectors. Accordingly, there may be at least one analog pressure sensor in communication with the fuel pump outlet to provide the FSCU with an indication of the fuel pump output pressure.

According to the invention the FSCU may control also the vapour management in the fuel system. As already mentioned, the purging of the fuel vapour canister is under the control of the FSCU. This control can be dealt with through a purge control valve (e.g. three-way switching valve embodied in a solenoid actuator) that allows communication between the canister and the engine air intake system. The actuator opens the purge control valve under a predetermined operating condition of the engine to connect the canister and the air intake system, thereby generating a purge gas flow through the canister.

According to another particular embodiment of the invention, the FSCU also may include functionality (like solenoid relays) to provide indication of a refueling event of the fuel tank, to control vapour venting of the fuel system, and/or to control an additive dosing system and to control a capless fill head.

The FSCU advantageously also communicates with the ECS preferably via the vehicle CAN bus. Through this multiplex bus, the ECS may communicate with the FSCU in order to send and receive sensor readings, algorithmically generated information, and commands to trigger actions. For instance, the ECS may send messages to the FSCU to enable the fuel pump, to control the output pressure of the fuel pump if a variable speed fuel pump is provided, to disable the fuel pump in the event of a vehicle accident, to control the purging of the vapor canister, to indicate the ambient temperature, to indicate the engine temperature and to request information from one or more sensors such as OBD sensors.

It is generally preferred that the ECS corresponds to the engine control unit or ECS of the vehicle.

It is preferred that the FSCU is a low power microprocessor, e.g. with a voltage of 5V. This type of microprocessor may have advantageously the following allocations: a ROM of 128 kilobytes, a volatile memory of 4 kilobytes and a non-volatile memory of 2 kilobytes.

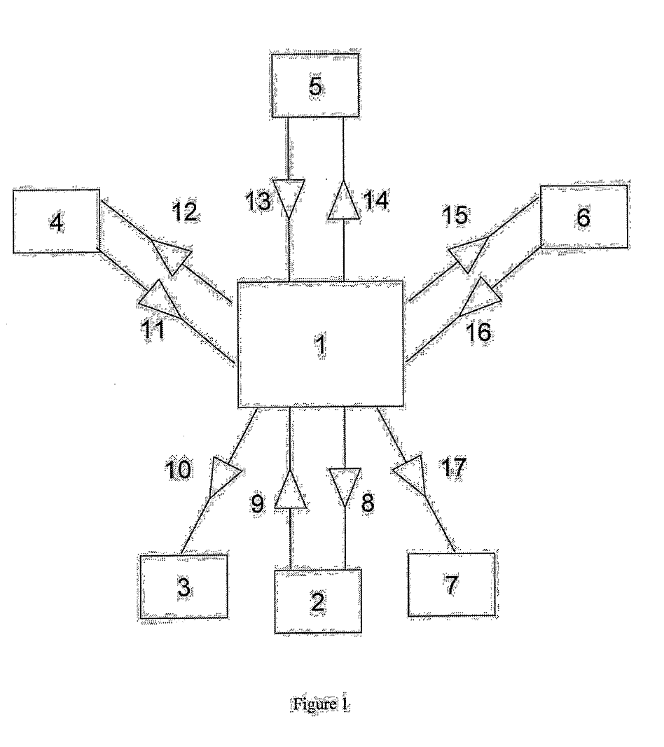

FIGS. 1 to 7 which follow are given with a view to illustrating the invention without restricting its scope.

FIG. 1 describes the basic functions of the system.

Microprocessor (1) communicates with the FSCU (2), including, but not limited to the transmission of the current fuel level (8), and reception of the current throttle position (9).

Microprocessor (1) controls the fuel delivery module (3) via an electrical signal (10).

It also receives fuel level data (11) from sensors (4).

Optionally, tank pressure and fuel level data (14) are sent by the FSCU (1) to a dynamic vapour management module (5).

On-Board diagnostics sensors (6) inform the FSCU (1) on the pressure condition (16) in the tank.

The FSCU controls a multi-function valve to canister (17), in particular for purging the canister.

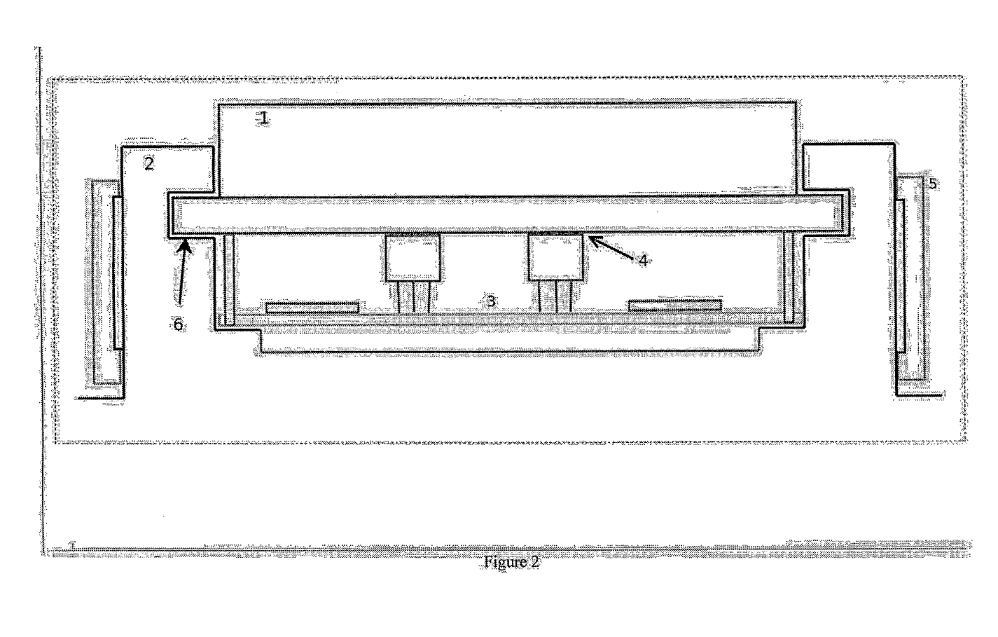

FIGS. 2 to 7 aim at demonstrating several ways of fixing the microprocessor on the tank.

They respectively picture:

FIG. 2: Slide in Flange Horizontal Mounting Side Cross-Section View:

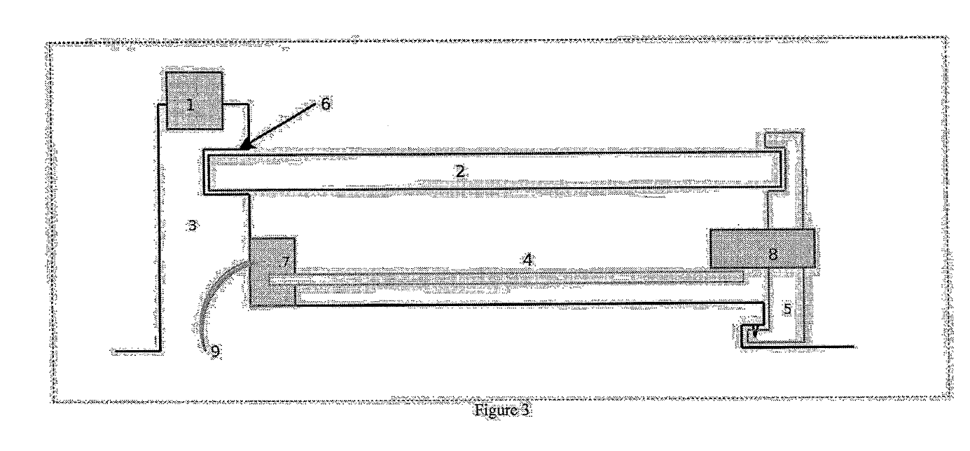

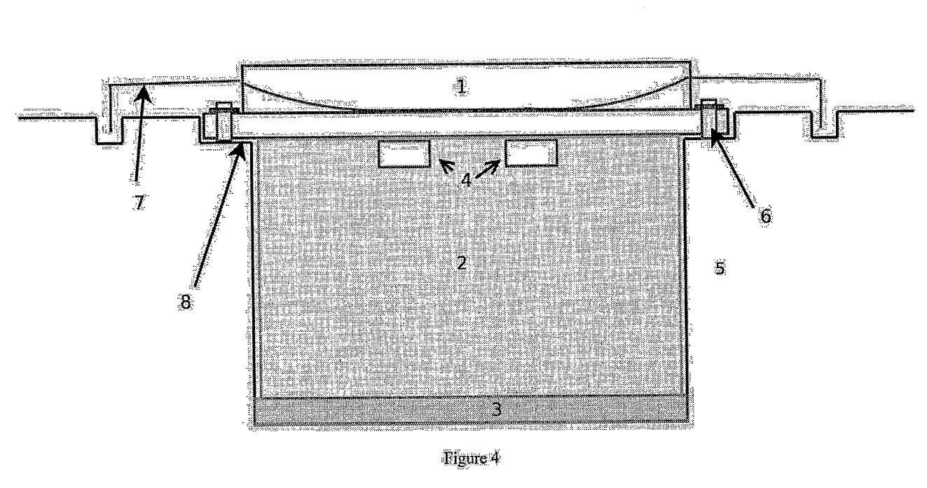

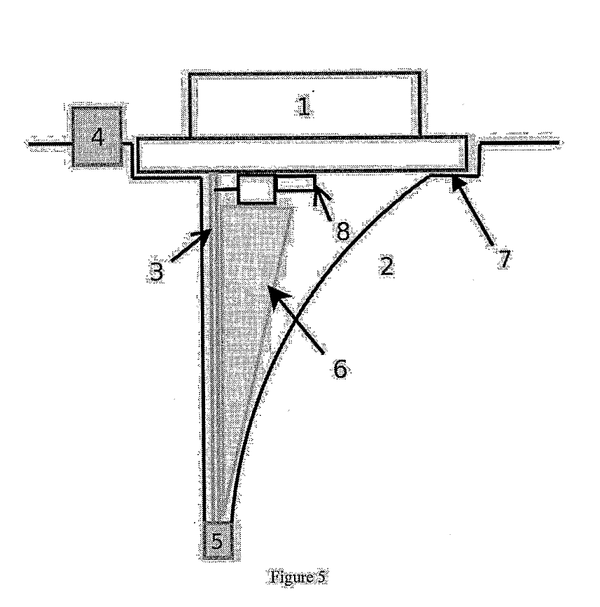

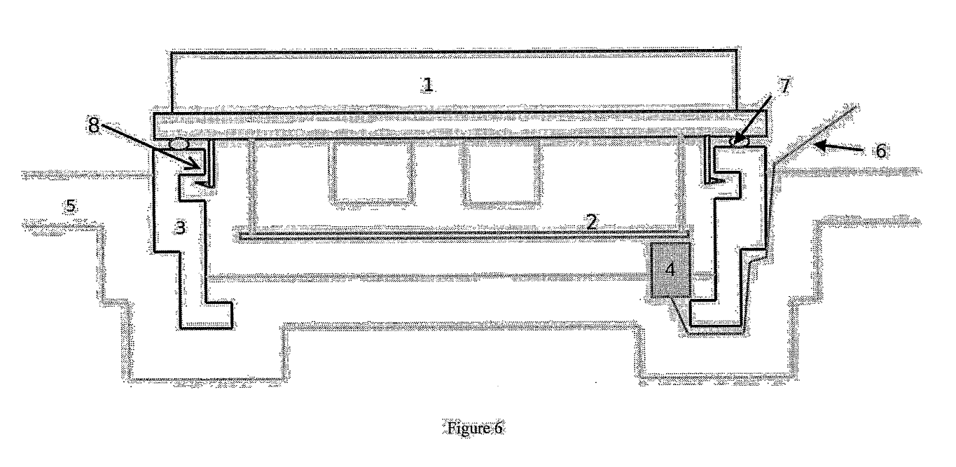

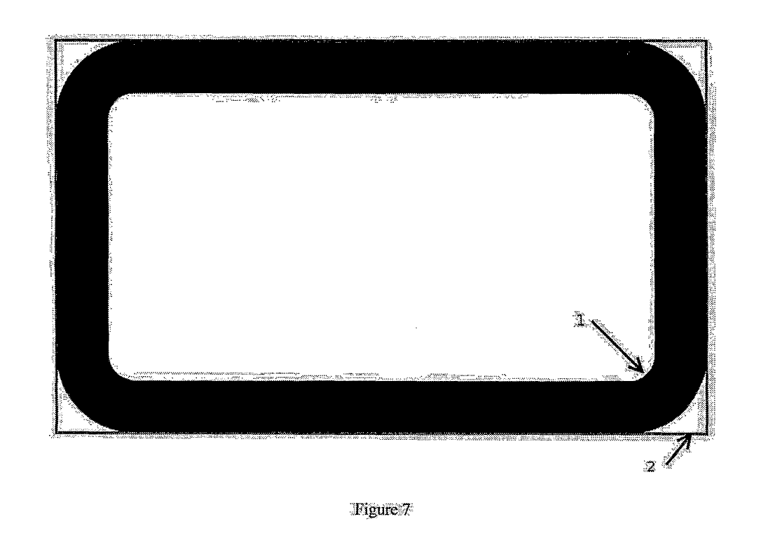

1. Heat Sink (or other cover)
2. Cavity wall molded into flange
3. Electronics in sealed cavity
4. Mating surface for components that require additional power/heat dissipation
5. Clip to secure assembly
6. Sealing surface between cover and cavity will require a gasket or other sealing material
   FIG. 3: Slide in Flange Horizontal Mounting Front View:
1. External connector integrated into flange, with hard wires to 7 (option).
2. Heat sink (or other cover)
3. Cavity wall molded into flange
4. Electronics in sealed cavity
5. Clip to secure assembly
6. Sealing surface between cover and cavity will require a gasket or other sealing material
7. Internal connector for electronics with connections to inside of tank (9) and optionally to exterior of tank (1)
8. External connector integrated into electronics assembly (option).
9. Wiring harness to interior of tank
   FIG. 4: Vertical Slot on Flange Front Cross Section View:
1. Heat sink (or other cover)
2. Electronics in sealed cavity
3. Internal connector for electronics with connections to inside (not shown) and outside (FIG. 4) of tank.
4. Mating surface for components that require additional power/heat dissipation
5. Cavity wall molded into flange
6. Post and e-clip or pin mounting options
7. External retainer clip mounting option
8. Sealing surface between cover and cavity will require a gasket or other sealing material
   FIG. 5: Vertical Slot on Flange Side Section View:
1. Heat sink (or other cover)
2. Cavity wall molded into flange
3. Electronics in sealed cavity
4. External connector integrated into flange, wired to (5)
5. Internal connector for electronics with connections to inside (not shown) and outside (4) of tank.
6. Optional potting or sealing material to protect electronics or to assist in cavity seal.
7. Sealing surface between cover and cavity will require a gasket or other sealing material
8. Mating surface for components that require additional power/heat dissipation
   FIG. 6: Horizontal Mounting in Tank Cavity Formed Using Metal Form Side View:
1. Heat sink (or other cover)
2. Electronics in sealed cavity
3. Steel (or other material) mounting insert into tank wall to create cavity and mounting surface.
4. Internal connector for electronics with connections to exterior and interior of tank through external wiring harness (6)
5. Tank surface material
6. External wiring harness bundle (may optionally be implemented with a connector on the surface of the tank), with connections to components outside and inside (through the flange or other opening) of the tank
7. Sealing surface between cover and cavity will require a gasket or other sealing material
8. Heat sink clip mounting option
   FIG. 7: Horizontal Mounting in Tank Cavity Formed Using Metal Form Top View:
1. Steel (or other material) mounting insert into tank wall to create cavity and mounting surface. The insert may be rounded at the corners to facilitate the blow molding process.
2. Profile of heat sink or other covering.

1. A fuel system for an internal combustion engine operating with the aid of an engine control system, the fuel system comprising a fuel tank, at least one fuel system component exercising at least one function and a fuel system control unit (FSCU) controlling at least said function, the FSCU
a) being separated from the engine control system,
b) being external to the fuel tank.

2. The fuel system according to claim 1, wherein the FSCU
a) has means for controlling functions of the fuel system,
b) is connected with the at least one fuel system component to send signals or receive signals from said at least one fuel system component,
c) is connected with at least one sensor that sends signals to the FSCU and/or the engine control system, either directly or on a network system contained within the vehicle.
d) is adapted to electronically communicate with the engine control system.

3. The fuel system according to claim 1, wherein the FSCU is mounted to the fuel tank.

4. The fuel system according to claim 3, wherein the FSCU is mounted to a tank flange.

5. The fuel system according to claim 4, wherein the tank flange is the fuel delivery module flange.

6. The fuel system according to claim 3, wherein the FSCU is mounted in a recess either in the tank wall, or in the flange.

7. The fuel system according to claim 6, wherein the recess is a recess in the tank wall molded by using a stamped steel ring.

8. The fuel system according to claim 6, wherein the recess integrates a heat sink as part of a cover.

9. The fuel system according to claim 3, wherein the FSCU is mounted to a moulded-in element on the tank wall.

10. The fuel system according to claim 3, wherein the FSCU is located in a casing that is welded to the tank wall.

11. The fuel system according to claim 1, wherein said at least one fuel system component is chosen among
a) a fuel pump which draws fuel from the fuel tank and discharges fuel from the fuel tank through an opening in the fuel tank wall,
b) a fuel vapour canister that is disposed within the fuel tank and through which any air received into or discharged out of the fuel tank travels,
c) one or more vapour or roll-over type valves communicating with the fuel vapour canister,
d) or any other type of fuel system component,
and wherein said at least one sensor is chosen among an electronic fuel level sensor, a temperature sensor, a pressure sensor, a hydrocarbon vapour sensor, an On-Board-Diagnostic (OBD) sensor or any other type of sensor.

12. The fuel system according to claim 11, wherein the FSCU controls the application of electrical power to the fuel pump.

13. The fuel system according to claim 11, wherein the FSCU generates a pulse-width-modulated current to control the fuel pump speed.

14. The fuel system according to claim 11, wherein the at least one pressure sensor is in communication with the fuel pump outlet to provide an indication of the fuel pump output pressure to said FSCU.

15. The fuel system according to claim 11, wherein the FSCU controls the vapour management in the fuel system.

16. The fuel system according to claim 11, wherein the FSCU controls the purging of the fuel vapour canister.

17. The fuel system according to claim 11, wherein the FSCU controls the detection of failure in an evaporative emission control system.

18. The fuel system according to claim 11, wherein the FSCU controls any fuel or vapour leakage out of the fuel system.

19. The fuel system according to claim 11, wherein the FSCU comprises a relay to provide indication of a refueling event of the fuel tank.

20. The fuel system according to claim 1, wherein the FSCU comprises a vent solenoid relay to control vapour venting of the fuel system.

21. The fuel system according to claim 1, wherein the FSCU comprises a relay to control an additive dosing system.

22. The fuel system according to claim 1, wherein the FSCU comprises a relay to control a capless fill head.

23. The fuel system according to claim 1, wherein the FSCU detects pressure conditions in the fuel tank.

24. The fuel system according to claim 1, wherein the FSCU communicates with said engine control system via a vehicle CAN bus.

25. The fuel system according to claim 1, wherein said engine control system external to the fuel tank is a vehicle engine control system (ECS).

26. The fuel system according to claim 1, wherein the FSCU is a low power microprocessor.
